(19) United States
(12) Patent Application Publication
(10) Pub. No.: US 2025/0353348 A1
(43) Pub. Date: Nov. 20, 2025

(54) THERMAL MANAGEMENT SYSTEM FOR EFFICIENT HEAT DISSIPATION

(71) Applicant: Vazirani Automotive Pvt. Ltd., Mumbai (IN)

(72) Inventors: Chandan Vazirani, Mumbai (IN); Siddhesh Bhikole, Thane (IN)

(73) Assignee: Vazirani Automotive Pvt. Ltd., Mumbai, MH (IN)

(21) Appl. No.: 19/287,930

(22) Filed: Aug. 1, 2025

(30) Foreign Application Priority Data
Feb. 1, 2023 (IN) 202321006573

(51) Int. Cl. B60H 1/00

(52) U.S. Cl. CPC B60H 1/00278

(57) ABSTRACT

The present disclosure relates to a thermal management system for a battery. The system comprises a solid component and a liquid conveying component for efficient heat dissipation in a battery comprising plurality of cells enclosed in a casing. The solid component is a powder mixture comprising organic and inorganic compounds mixed in optimum ratio for exchanging heat with the plurality of cells. The liquid cooling component comprises of plurality of liquid conveying component arranged for the flowing liquid coolant to exchange heat with the solid component and conveying the heat out of the battery.

### FIELD OF TECHNOLOGY

The present disclosure generally relates to a thermal management system for a battery. More particularly, the disclosure relates a thermal management system comprising a solid component in powder form and a liquid conveying component, one or more sensors, a pump, and a heat exchanger, for keeping a temperature of the cells in a battery within a predefined range of temperatures.

### BACKGROUND

Electric vehicles (EV) mostly use Li-ion battery cells to power its drivetrain. The optimum operational temperature for these cells is between 10 and 50° C. Accumulation of heat in the battery might lead to thermal runaway. At the same time, temperatures below the recommended limit impact the performance of the cells. To maintain the temperature in the optimum operational range, a thermal management system is needed which cool or heat the cells in a battery system as and when required. This system could be an active solution which uses pumps and radiators to drive the heat away from the cells or a passive system such as extended finned surfaces utilizing convection cooling. This system also needs to be as much efficient as possible to reduce load on battery storage and to maximize the range of the vehicle.

The most common technology used for maintaining the thermal balance in an EV is liquid cooling. In this technique, multiple fluid lines and pathways are made running from each cell to the radiator which can be cooled with atmospheric air or a chiller running on vehicle's power supply. In a condition where the cells need to be heated, when the ambient temperature is below the battery's optimum performance range, a heater is used to heat a fluid which then passes through the battery and warms the cells. Another method is to use a phase change material (PCM) which surrounds the cells. Such materials have a high latent heat and thus, absorb a large amount of heat while undergoing phase change. There are different types of PCMs ranging from organic to synthesized chemicals. These materials, in some cases, become completely fluid or semi-solid depending on the temperature it is exposed to. However, the use of a PCM as a heat transfer element can rapidly remove heat corresponding to their latent heat of phase change but PCM materials also impart stress in all directions when they expand due to the rise in their temperature.

Therefore, there is need of a thermal management system which can be effectively used in a battery to keep the temperature of the cells in the battery within a pre-defined range.

### SUMMARY

To overcome or mitigate at least some of the problems in the state of the art, the present disclosure provides a thermal management system for a battery, the battery comprising a plurality of cells enclosed in a casing, the thermal management system comprises a solid component in powder form in contact with the outer surfaces of the plurality of cells and substantially filling the interstices between the plurality of cells. It also comprises a liquid conveying component configured to exchange heat with one of the solid component, the cell surface, and both. The system also comprises one or more sensors configured for sensing a temperature of one of, one or more cells, the solid component, and the liquid conveying component. The system also comprises a pump for circulating a coolant through the liquid conveying component and a heat exchanger, located outside the battery, in fluid communication with the liquid conveying component for exchanging heat, for keeping a temperature of the cells in the battery within a predefined range of temperatures.

### OBJECTIVES

It is the main objective of the present disclosure to provide a thermal management system for heat dissipation.

It is another objective of the disclosure to provide a thermal management system for efficient heat dissipation in batteries.

### BRIEF DESCRIPTION OF THE DRAWINGS

These and other features, aspects, and advantages of the exemplary embodiments can be better understood when the following detailed description is read with reference to the accompanying drawings in which like characters represent like parts throughout the drawings, wherein:

FIG. 1 depicts an isometric view of a thermal management system in battery of Type A.

FIG. 2 depicts a top view of thermal a management system in battery of Type A.

FIG. 3 depicts an isometric view of a thermal management system in battery of Type B.

FIG. 4 depicts a top view of a thermal management system in battery of Type B.

FIG. 5 depicts an isometric view of a thermal management system in battery of Type C.

FIG. 6 depicts a sectional view of a thermal management system in battery of Type C.

FIG. 7 depicts an isometric view of a thermal management system in battery of Type D.

FIG. 8 depicts a top view of thermal a management system in battery of Type D.

FIG. 9 depicts an isometric view of a thermal management system in battery of Type E.

FIG. 10 depicts a top view of a thermal management system in battery of Type E.

FIG. 11 depicts an isometric view of a plate type heat exchanger.

FIG. 12 depicts a sectional view of a plate type heat exchanger.

FIG. 13 illustrates a comparative graph of thermal performance of battery without any thermal management system, with the solid component powder mixture, with the solid component powder mixture and air-cooling arrangement with fins, and with the solid component powder mixture and the liquid conveying component for heat dissipation, when measured using a specific type of cell with an allowed peak discharge of 20C (wherein the C rating is numerically equal to the Ampere-hour (Ah) rating of the battery. So, a discharge rate of 20C for a 1 Ah battery is 20 Amperes), in accordance with one embodiment of the present disclosure.

FIG. 14 illustrates a comparative graph of thermal performance of battery without any thermal management system, with the solid component powder mixture, with the solid component powder mixture and air-cooling arrangement with fins, and with the solid component powder and the liquid conveying component for heat dissipation, when measured using a specific type of cell with an allowed peak discharge of 4C, in accordance with one embodiment of the present disclosure.

### DETAILED DESCRIPTION

For the purpose of promoting an understanding of the principles of the disclosure, reference will now be made to the embodiments and specific language will be used to describe the same. It will nevertheless be understood that no limitation of the scope of the disclosure is thereby intended, such alterations and further modifications in the illustrated composition, and such further applications of the principles of the disclosure as illustrated therein being contemplated as would normally occur to one skilled in the art to which the disclosure relates. Unless otherwise defined, all technical and scientific terms used herein have the same meaning as commonly understood by one of ordinary skilled in the art to which this disclosure belongs. The composition, methods, and examples provided herein are illustrative only and not intended to be limiting.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

Unless defined otherwise, all technical and scientific terms used herein have the same meaning as commonly understood by one of ordinary skill in the art to which this disclosure belongs. Although any methods and materials similar or equivalent to those described herein can be used in practice or testing of the teachings of the disclosure, the preferred methods, and materials are now described.

The terminology and structure employed herein are for describing, teaching, and illuminating some embodiments and their specific features and elements and do not limit, restrict, or reduce the spirit and scope of the disclosure.

In a general arrangement, a solid cooling component and a liquid cooling component are put together in a battery for thermal regulation. The various parts of the two-way thermal management system are as defined herein.

The solid component is “DiCo”, which is the primary thermal management material used in the present disclosure that fills the interstitial spaces between the cells of the battery and the liquid conveying component. The solid component is a mixture of multiple compounds in specific quantities made with a controlled process for optimum performance.

The term “DiCo” used hereinafter refers to a specifically configured powder mixture which includes various inorganic components and at least one organic component i.e., C₁₅H₂₄ which belongs to the sesquiterpenoid family and is generally known by the name isocaryophyllene, while other nomenclature may also be used and is completely disclosed in Indian patent application Ser. No. 202121024470, the contents of which are incorporated herein by reference.

The solid component “DiCo” which is a specifically configured synergistic powder mixture for heat dissipation that has both organic and inorganic compounds as its constituents. An organic constituent material is C₁₅H₂₄ and the inorganic constituents of the powder mixture include, but are not limited to, at least one carbonate, at least one oxide, and at least one oxalate that are selected form calcium carbonate, silicon dioxide, neodymium praseodymium oxalate, and two or more materials selected from the group consisting of ammonium chloride, zirconium dioxide, zirconium sulphate, zirconium carbide, zirconium metal, iron oxide, and carbonyl iron. While calcium carbonate, silicon dioxide, and neodymium praseodymium oxalate are specifically noted, other carbonates, oxides, and oxalates may also be used in conjunction with these materials. Further, along with the two or more selected materials, other similar or dissimilar materials may also be included for imparting application specific properties to the powder mixture.

“DiCo” powder is a thermal management solution which also works as a packing material around the cells providing structural support and protection against thermal runaways.

The liquid conveying component is used to run a suitable liquid coolant such as water or a mixture of water and glycol through the battery to carry away the heat from the plurality of cells. The coolant flowing through these liquid conveying components dissipate the heat very rapidly. To produce and regulate the flow of the coolant a pump is used. A radiator is used as a heat sink to dump the heat outside. These are made up of metals such as aluminium, for example.

Cells are available in different shapes and sizes. These cells could also be in cylindrical, pouch, prismatic, or rectangular forms. The primary function of these cells is to store electric energy in chemical form and release when demanded. This reversible reaction happens for each charge and discharge cycle. The efficiency of conversion largely depends on temperature. While charging or even discharging cells produce large amounts of heat that needs to be removed for optimum working of the cells.

Casing is an enclosure which holds the whole assembly of cells together and provides structural support.

According to an embodiment, the present disclosure discloses a thermal management system for a battery with a unique structural arrangement, wherein the thermal management system efficiently dissipates excessive heat generated from the battery. The thermal management system broadly comprises of an arrangement of solid cooling component and liquid cooling component cooperatively working for heat dissipation. The thermal management system is particularly useful in extreme conditions when a standalone solid cooling component is not sufficient, and the liquid cooling component works alongside to aid heat dissipation. This unique combination of solid cooling component and liquid cooling component is efficient in terms of cooling the batteries compared to other existing solutions. The solid cooling component is the primary part of this system, which is functional throughout the operations whereas the liquid cooling component is activated only when the thermal loads are such that the solid cooling alone cannot dissipate the heat produced. This system is configured in such a way as to minimize the operation of power consuming liquid conveying component and mostly relying on the solid component for passive cooling to be energy efficient.

The two-component heat dissipation system as described herein can be effectively used in any heat producing device, including electronic and electrochemical devices. Specifically, the two-component heat dissipation system developed and described herein is effective in various types of modular battery systems for electric vehicles for cooling, and preventing thermal runaway, explosion, and thermal overload.

The figures show various types of battery configurations the different components of which are represented by the numerals 1: a solid cooling component DiCo, 2: Li-ion cylidrical Cell, 3: Li-ion prismatc cell, 4: casing, 5: cooling plate, 6: liquid cooling channel, 7: thermal pad, 8: compression pad, 9: metal casing with fins, 10: fins, 11A: top cover lid, 11: outlet for terminal, 12: handle, 13: modular plastic casing, 14: ribs, 15: outlet for detachable terminals, 16: coolant inlet, 17: refrigerant inlet, 18. coolant outlet, 19: refrigerant outlet, 20: separator plate, 22: heat exchanger metal casing, 23: separator tube are described in different embodiments below:

The present disclosure provides a thermal management system for a battery, the battery comprising a plurality of cells enclosed in a casing, the thermal management system comprising a solid component in powder form in contact with outer surfaces of the plurality of cells and substantially filling the interstices between the plurality of cells; a liquid conveying component configured to exchange heat with one of the solid component, the cell surface, and both; one or more sensors configured for sensing a temperature of one of, one or more cells, the solid component, and the liquid conveying component; a pump for circulating a coolant through the liquid conveying component; and a heat exchanger, located outside the battery, in fluid communication with the liquid conveying component for exchanging heat, for keeping a temperature of the cells in the battery within a predefined range of temperatures.

According to an embodiment of the present disclosure, the liquid conveying component comprises a one or more tubes for circulating a liquid through the battery.

According to another embodiment of the present disclosure, the liquid conveying component is a metal block configured for being in contact with at least one or more of one surface of the battery, the solid component and both, and the block has channels for conveying a coolant liquid through the metal block.

According to another embodiment of the present disclosure, the coolant liquid is one of water, glycol, and a mixture of water and glycol in a predetermined ratio.

According to another embodiment of the present disclosure, the heat exchanger is selected from one of a radiator, a chiller, a heater, and a chiller-heater.

According to another embodiment of the present disclosure, the casing of the battery has an outer surface configured as one of a ribbed surface and fins, for improved heat dissipation.

According to another embodiment of the present disclosure, the casing is made up of one of aluminium and an aluminium composite.

According to another embodiment of the present disclosure, the flow of the liquid being conveyed through the liquid conveying component is controlled by one or more flow control valves.

According to another embodiment of the present disclosure, the one or more tubes are positioned in one of a position to pass in proximity to each of the plurality of cells, and to be in contact with a bottom surface of each of the plurality of cells.

According to another embodiment of the present disclosure, one or more sensors, located so as to measure one or more temperatures related to the battery and its cells, are communicatively connected to a controller configured for processing one or more signals from the one or more sensors for one or more of controlling the flow of liquid through the liquid conveying component and controlling one of heater, chiller, and chiller-heater.

According to an embodiment of the present invention, the battery is Li-ion battery.

According to an embodiment of the present invention, the plurality of cells is interconnected in one of series, parallel, and series-parallel configuration.

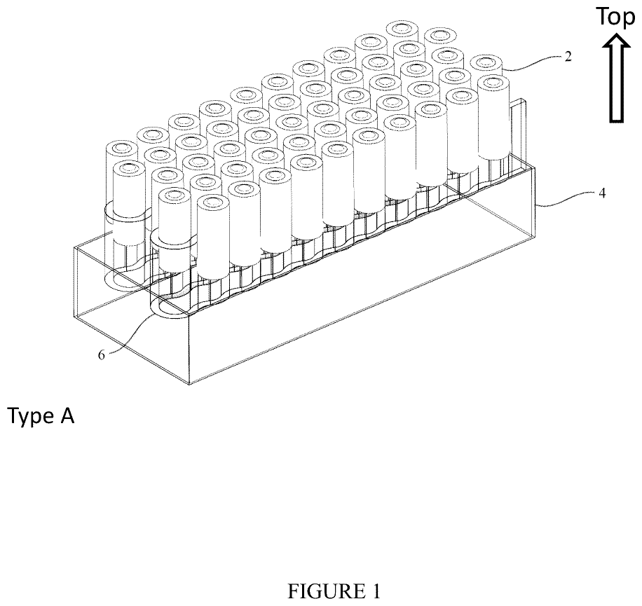

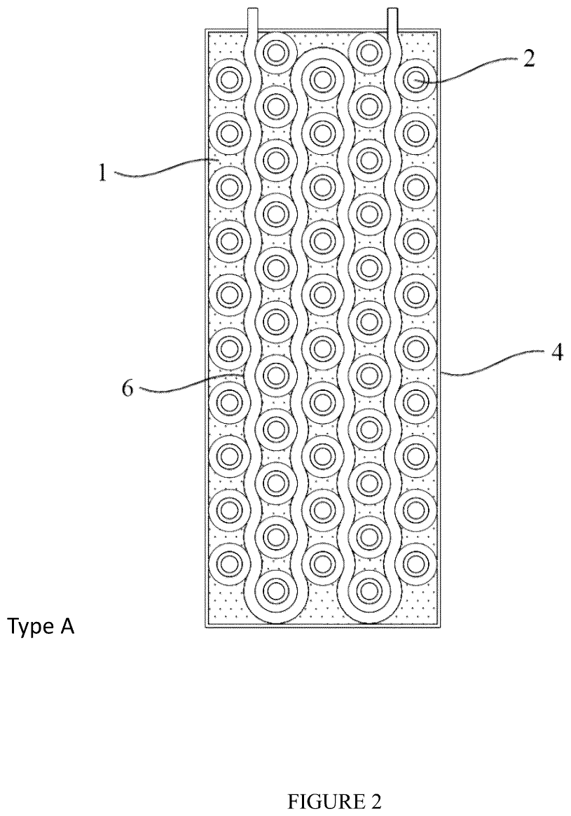

According to an embodiment of the present disclosure, the thermal management system for a battery of Type A comprising plurality of cells 2 each in contact with a liquid conveying component 6 enclosed in a casing 4 is shown in FIG. 1 and FIG. 2. In this type of battery, electrical connections are present on the upper side of the plurality of cells or on one of the sides perpendicular to the major axis of the plurality of cells in the battery depending on the bus bar configuration. The liquid conveying component 6 radially contacts the outer surfaces of the plurality of cells 2. This type of battery configuration provides surface area of contact with the cell. The interstitial spaces present between the cells 2 and the liquid conveying component 6 may be filled with the solid component 1 in powder form which acts as the thermal management system and at the same time helps in efficient close packing of the cells inside the casing 4. Further, a coolant is used to circulate through the liquid conveying component 6, which provides additional cooling to the battery depending on the temperature conditions.

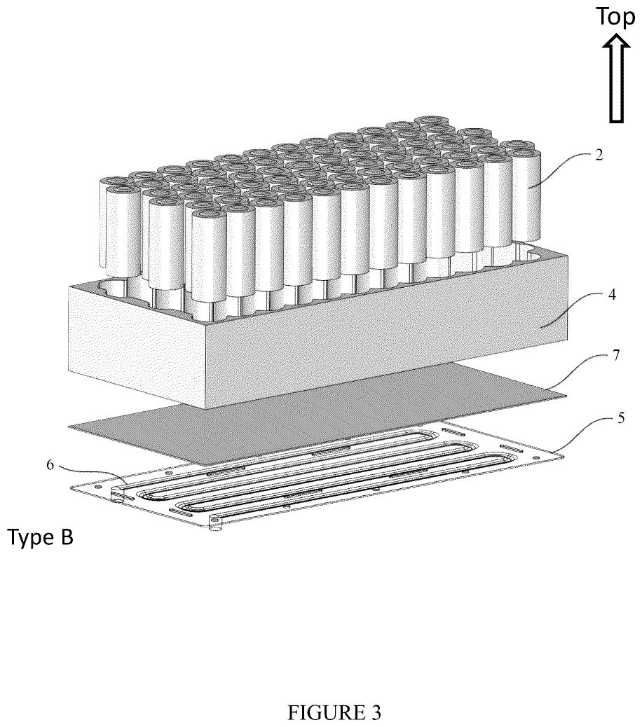

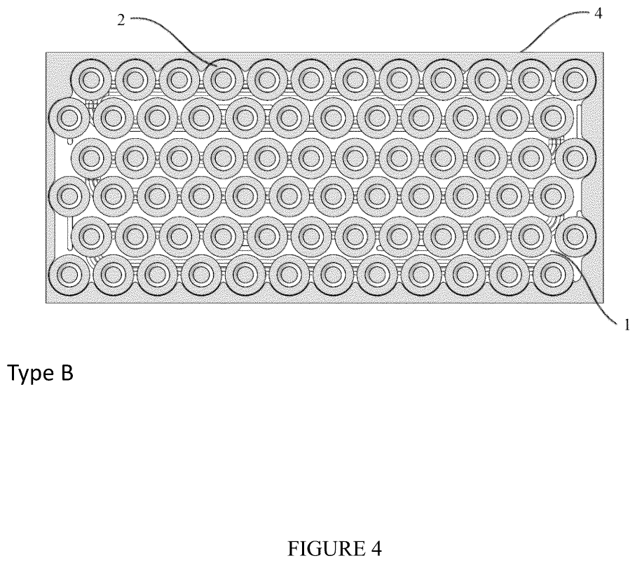

According to another embodiment of the present disclosure, the thermal management system for a battery of Type B comprising plurality of cells 2 enclosed in a casing 4 is shown in FIG. 3 and FIG. 4. In this battery, bus bar and all the electrical connections are configured on the upper side of the plurality of cells. as depicted in FIG. 1. The bottom of the plurality of cells, as depicted in FIG. 1 are in contact with a thermal pad 7. One surface of the thermal pad is in direct contact with the base of cells 2 and the other surface is in contact with a cooling plate 5. The cooling plate 5 is made such that a liquid coolant flows through the liquid conveying component 6 made inside it, to remove heat. The excess heat from cells 2 flows to the surrounding solid component 1 and then through the thermal pads 7 and gets extracted via the liquid conveying component 6 present in cooling plate 5. This arrangement is suitable for cylindrical cells of any format.

Typically, in the state of the art, in this type of battery the interstitial spaces between the cells are mostly empty or filled with some structural foam such as polyurethane (PU). PU only gives structural support and increases the battery rigidity but it not useful as a thermal material. Similar is the case with empty spaces when filled with air. Introducing the solid component in interstitial spaces of this type of battery solves two problems. The solid component acts as a thermal management material and at the same time provides structural rigidity. Thus, the battery, wherein the interstitial spaces are filled with the solid component is more efficient thermally as well as electrically as it needs less cooling power to maintain its optimal temperature.

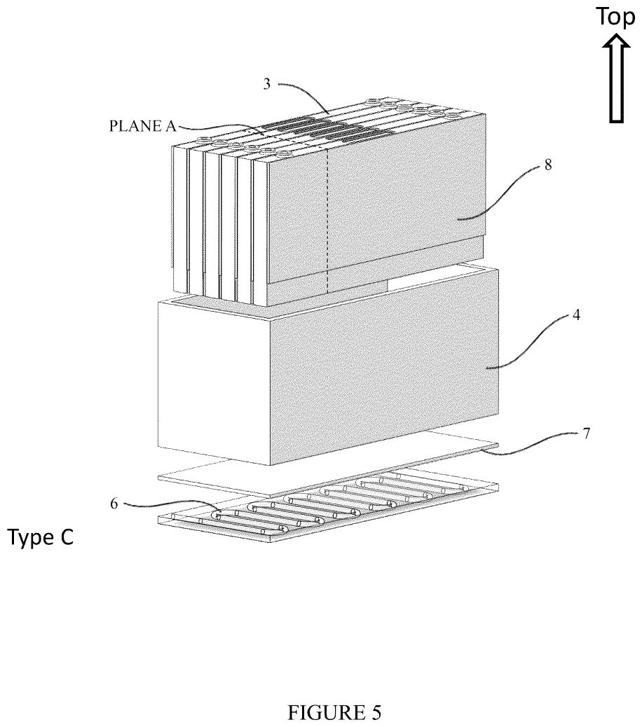

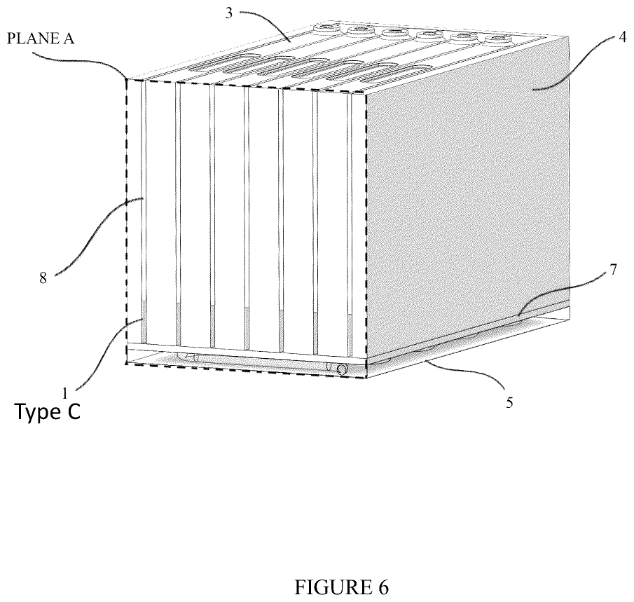

According to another embodiment of the present disclosure, the thermal management system for a battery of Type C comprising plurality of prismatic type cells 3 enclosed in a casing 4 is shown in FIG. 5 and FIG. 6. In this type of cells 3 both the terminals are present on top of the cell. The outer cell covering is made from thermally conductive metal material for heat dissipation. Because of the cuboidal form factor there are no interstitial spaces. A compression pad 8 is used in between the cells 3 for rigidity and provide room in case the cells expand over time because of degradation. All these cells rest on a thermal pad 7 which is in direct contact with a cooling plate 5. Some interstitial spaces are created proximal to the thermal pad by shortening the length of compression pads 8. In this type of battery configuration, the solid component 1 can be introduced in the interstitial space created by shortening the length of compression pads 8 and multiple problems are solved. Typically, these spaces are filled with thermal resin to increase thermal contact between cells and thermal pads. However, the cost-effective solid component is also a compressible powder with thermal properties and hence replaces compression pads as well as thermal resin and thus, is a better replacement to thermal resin in such type of batteries.

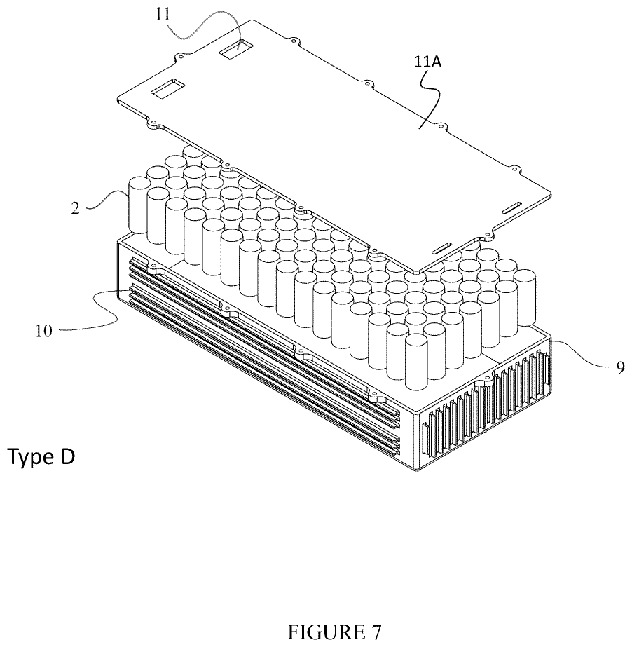

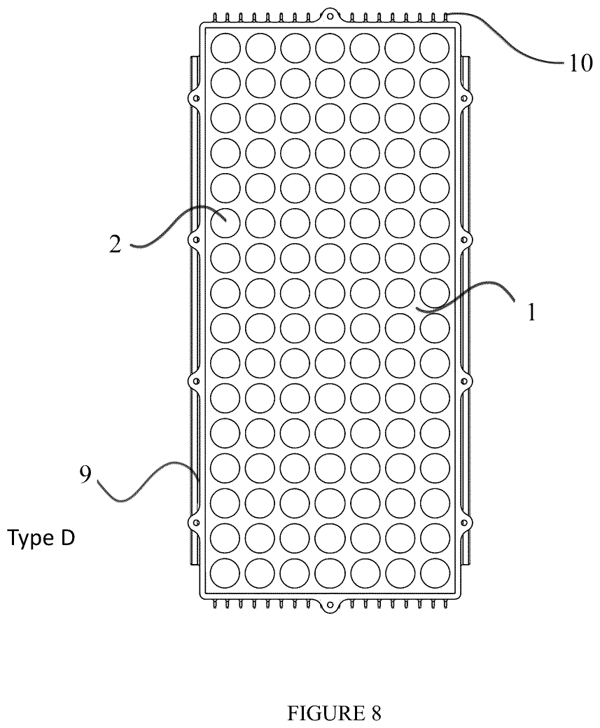

According to another embodiment of the present disclosure, the thermal management system for a battery of Type D comprising plurality of cylindrical cells 2 is shown in FIG. 7 and FIG. 8. Cell terminals are present on the end of the cells proximal to the top cover lid 11A having the outlet 11. Casing 4 of the battery is made up of a machinable light weight material such as aluminium. It is provided with extended finned surface geometry for better heat convection. A compression pad material similar to that described above with reference to battery of Type C is used in this as well but it is optional.

Typically, the interstitial spaces between the cells 2 are filled with thermal resins or any type of epoxy glue or foam to provide structural stability as well as thermal pathway between the cell and casing.

In this type of battery also, the solid component is introduced to replace the thermal resin and epoxy or foam. The solid component works both as a thermal interface as well as packing material. Depending on the requirement, different types of cells are introduced in this type of battery configuration. Using solid component in this type of battery increases the overall effectiveness of passive air cooling via fins.

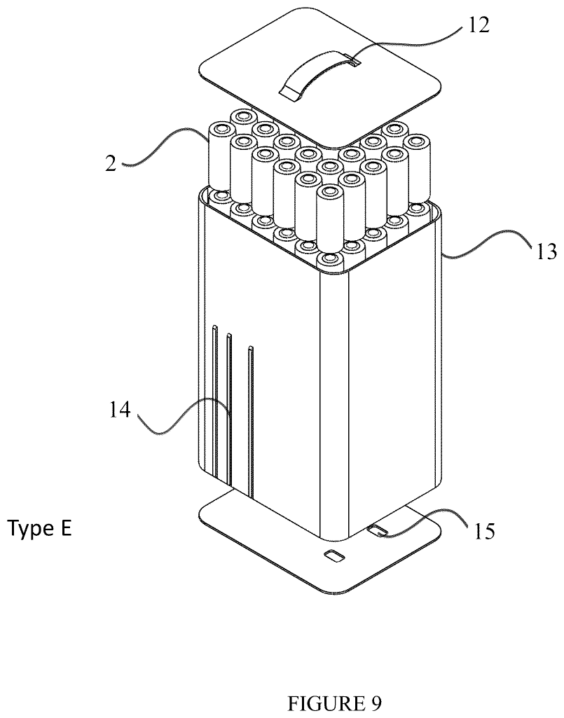

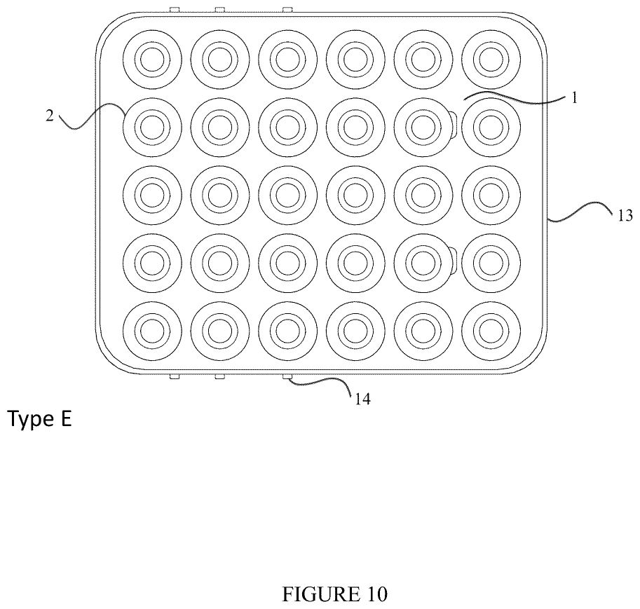

According to another embodiment of the present disclosure, the battery is a swappable battery, as shown in in FIG. 9 and FIG. 10, of Type E comprising cell 2 enclosed in a modular plastic casing 13 with a ribbed connector 14 and a cover is provided with a handle 12, wherein the battery can be removed easily for charging externally, facilitating instantaneous power refill for vehicles. FIG. 9 and FIG. 10 are schematic representations of swappable battery. The battery casing is durable and are configured to sustain repeatedly removing from a vehicle, fitting into to charger and fitting back to a vehicle. All the casings have uniform shape and energy storage capacity. The ribs connector 14 positioned on the casing such as to make the battery align perfectly with the vehicle onboard connectors for seamless power transfer. These types of batteries are most popular in two wheelers with short operation range and continuous operational requirements. The configuration can withstand multiple engagement and disengagement into and from vehicles. It is provided with detachable terminals having an outlet for detachable terminals 15 which connects the whole electrical power of the pack with the vehicle system. The connectors between the battery and vehicle are configured such that power coupling between the battery and vehicle is seamless. These types of batteries generally do not include any type of cooling system. The solid component 1 is introduced as a passive thermal management system surrounding the cell in this type of battery working as a thermal interface material as well as packaging agent.

According to another embodiment of the present disclosure, the thermal management system for a battery comprising cells 2, 3 packed inside the casing 4 and a refrigerant system working on vapour compression cycle (VCC), wherein a compressed liquid refrigerant is circulated to carry out the heat from the battery. The refrigerant may be circulated through the liquid conveying component 5 provided on casing 4 which is in direct contact with the cells.

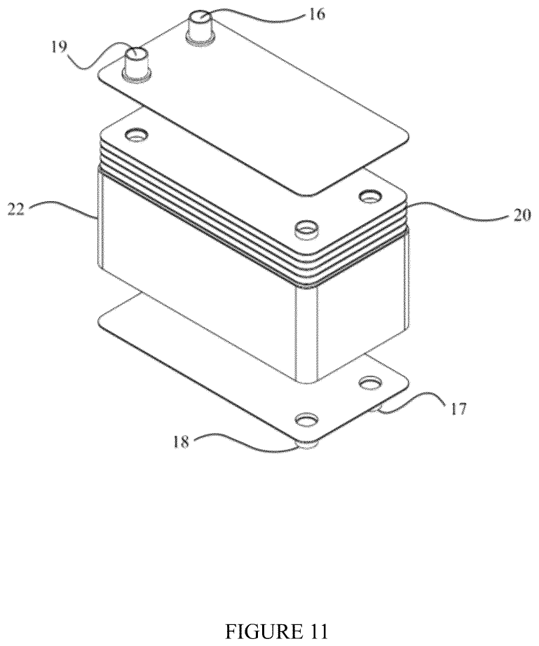

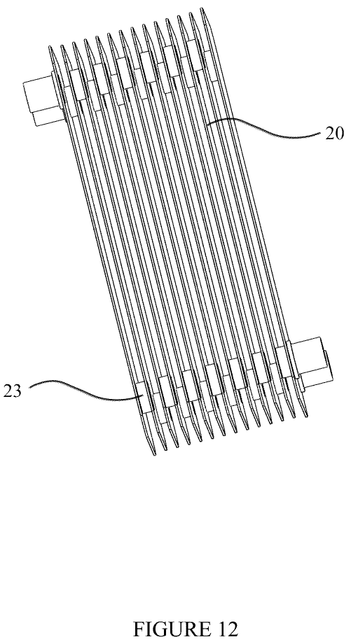

The solid component is introduced in this battery which enhances the overall effectiveness of the system making the cooling efficient. The solid component is placed around the cells 2, 3 surrounding it from all the sides. A plate type heat exchanger as shown in FIG. 11 and FIG. 12 is used to exchange heat between the refrigerant and coolant flowing through the battery. Any battery of Type A, Type B and Type C works with this type of arrangement along with plate type heat exchanger.

The thermal management system works for the battery having any type of Li-ion cell inside the casing, wherein the battery is used in adverse environmental conditions and a rapid and more intensive cooling is needed.

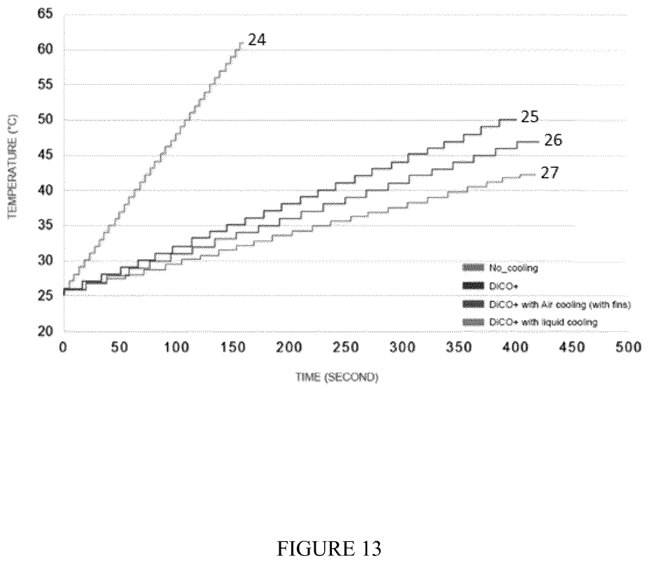

According to an embodiment of the present the plate type heat exchanger comprises a coolant inlet 16, a refrigerant inlet 17, a coolant outlet 18, a refrigerant outlet 19, a separator plate 20, and heat exchanger metal casing 22, and a separator tube 23. FIG. 13 illustrates a graph showing curves indicating thermal performance of a battery, without any thermal management system 24, with the solid component powder mixture 25, with air-cooling and fins 26, and with solid component powder mixture and liquid cooling 27, when measured using a specific type of cell with an allowed peak discharge of 20C. The curves in the graph appear stepped because the minimum deviation of temperature sensor used is 1° C.

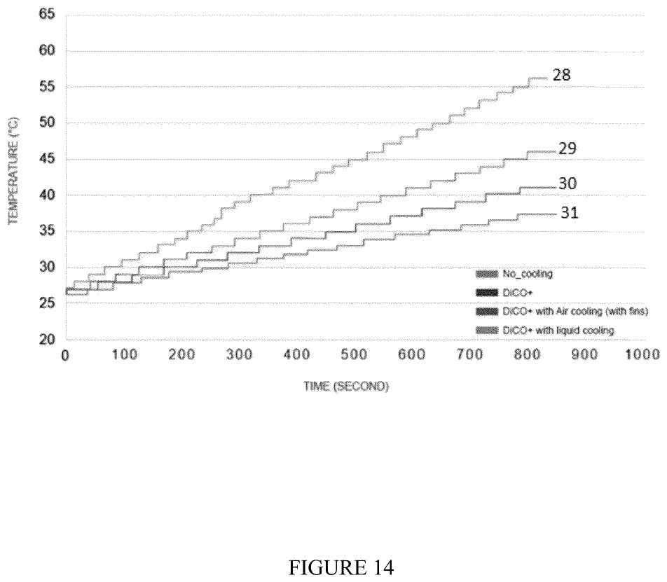

The curves in the graph are drawn for test cycle simulations of driving conditions of an automobile where the above-mentioned battery modules are used in similar driving conditions. The test conditions simulated here are similar to that disclosed above. The test cycle used herein discharges the complete cell from 100% SoC to 10% SoC in about 13 minutes. For an efficient thermal management system, the temperature of the cells should not reach above 60° C. as that can lead to thermal runaway and reduces the life of the cells if not cooled properly. The results clearly show that even in this very extreme high-power condition, the cell temperature in the battery that has only the solid component powder mixture, the solid component powder mixture with air-cooling and fins, and the solid component powder mixture and the liquid cooling as the heat dissipating medium do not surpass the operating limit of 60° C. For the battery that has the solid component powder mixture and the liquid cooling as the heat dissipating medium, the temperature remail below 45° C. FIG. 14 illustrates a graph showing curves indicating thermal performance of a battery, without any thermal management system 28, with the solid component powder mixture 29 with air-cooling and fins 30, and with solid component powder mixture and liquid cooling 31, when measured using a specific type of cell, with an allowed peak discharge of 4C.

In this case also, the cell temperature in the battery that has only the solid component powder mixture, the solid component powder mixture with air-cooling and fins, and the solid component powder mixture and the liquid cooling as the heat dissipating medium do not surpass the operating limit of 60° C. For the battery that has the solid component powder mixture and the liquid cooling as the heat dissipating medium, the temperature remail below 40° C.

The results from the following tests clearly indicates that however, the solid component powder mixture is helpful in managing the operating temperature of the battery in predefined range and the efficiency is further enhance by the addition of air-cooling and fins on battery casing, but the arrangement of liquid component along with the solid component powder mixture in a battery is most efficiently maintaining the operating temperature within predefined range.

While specific language has been used to describe the disclosure, any limitations arising on account of the same are not intended. As would be apparent to a person skilled in the art, various working modifications may be made to the method to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all the acts necessarily need to be performed. Also, those acts that are not dependent 10 on other acts may be performed in parallel with the other acts. The scope of embodiments is by no means limited by these specific examples. Numerous variations, whether explicitly given in the specification or not, such as differences in structure, dimension, and use of material, are possible.

We claim:

1. A thermal management system for a battery, the battery comprising a plurality of cells enclosed in a casing, the thermal management system comprising:
a solid component in powder form in contact with outer surfaces of the plurality of cells and substantially filling the interstices between the plurality of cells;
a liquid conveying component configured to exchange heat with one of the solid component, the cell surface, and both;
one or more sensors configured for sensing a temperature of one of, one or more cells, the solid component, and the liquid conveying component;
a pump for circulating a coolant through the liquid conveying component; and
a heat exchanger, located outside the battery, in fluid communication with the liquid conveying component for exchanging heat, for keeping a temperature of the cells in the battery within a predefined range of temperatures.

2. The thermal management system as claimed in claim 1, wherein the liquid conveying component comprises a one or more tubes for circulating a liquid through the battery.

3. The thermal management system as claimed in claim 1, wherein the liquid conveying component is a metal block configured for being in contact with at least one or more of one surface of the battery, the solid component and both, and the block has channels for conveying a coolant liquid through the metal block.

4. The thermal management system as claimed in claim 1, wherein the coolant liquid is one of water, glycol, and a mixture of water and glycol in a predetermined ratio.

5. The thermal management system as claimed in claim 1, wherein the heat exchanger is selected from one of a radiator, a chiller, a heater, and a chiller-heater.

6. The thermal management system as claimed in claim 1, wherein the casing of the battery has an outer surface configured as one of a ribbed surface and fins, for improved heat dissipation.

7. The thermal management system as claimed in claim 1, wherein the casing is made up of one of aluminium and an aluminium composite.

8. The thermal management system as claimed in claim 1, wherein the flow of the liquid being conveyed through the liquid conveying component is controlled by one or more flow control valves.

9. The thermal management system as claimed in claim 2, wherein the one or more tubes are positioned in one of a position to pass in proximity to each of the plurality of cells, and to be in contact with a bottom surface of each of the plurality of cells.

10. The thermal management system as claimed in claim 1, wherein the one or more sensors are communicatively connected to a controller configured for processing one or more signals from the one or more sensors for one or more of controlling the flow of liquid through the liquid conveying component and controlling one of heater, chiller, and chiller-heater.
